(19) United States
(12) Patent Application Publication
(10) Pub. No.: US 2008/0256271 A1
(43) Pub. Date: Oct. 16, 2008

(54) Methods and apparatus for reducing storage usage in devices

(76) Inventor: Paul T. Breed, Solana Beach, CA (US)

Correspondence Address: GAZDZINSKI & ASSOCIATES, 11440 WEST BERNARDO COURT, SUITE 375, SAN DIEGO, CA, 92127, US

(21) Appl. No.: 12/001,511

(22) Filed: Dec. 12, 2007

Related U.S. Application Data
(60) Provisional application No. 60/874,651, filed on Dec. 12, 2006.

(51) Int. Cl. G06F 13/14; G06F 12/02; G06F 12/00

(52) U.S. Cl. 710/52; 711/103; 711/104; 711/E12.002

(57) ABSTRACT

Transmission buffer apparatus and methods configured to minimize the storage requirements for transmission/retransmission of data by allocating retransmission data to two or more types of storage. In one embodiment, RAM usage in a RAM-limited embedded device is minimized by storing only a reference or pointer to ROM- or Flash-sourced within the retransmission buffer (e.g., RAM), thereby reducing the storage burden on the buffer. For example, web pages having largely non-volatile components can be stored in ROM or Flash, while only the dynamic or volatile portions are stored in RAM. Apparatus and methods for implementing an exemplary serial-to-Ethernet interface are disclosed, as well as use of Flash or ROM to store configuration data in the form of e.g., a web page image. A circular buffer approach implementing the aforementioned methodologies is also described.

### PRIORITY

This application claims priority to U.S. provisional patent application Ser. No. 60/874,651 filed Dec. 12, 2006 of the same title, which is incorporated herein by reference in its entirety.

### COPYRIGHT

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### 1. FIELD OF THE INVENTION

The present invention relates generally to the field of data storage and transmission with computerized systems, and specifically to methods and apparatus for efficient use of storage space for, inter alia, implementing network retransmission functions.

### 2. DESCRIPTION OF RELATED TECHNOLOGY

Various methods and apparatus exist in the prior art for the storage of data utilized or transmitted in data processing or transmission systems. For example, U.S. Pat. No. 5,805,816 to Picazo, Jr., et al. issued Sep. 8, 1998 and entitled “Network packet switch using shared memory for repeating and bridging packets at media rate” discloses a hub circuit with an integrated bridge circuit carried out in software including a switch for bypassing the bridge process such that the two bridged networks effectively become one network. An in-band management process in software is disclosed which receives and executes network management commands received as data packets from the LANs coupled to the integrated hub/bridge. Also, hardware and software to implement an isolate mode where data packets which would ordinarily be transferred by the bridge process are not transferred except in-band management packets are transferred to the in-band management process regardless of which network from which they arrived. Also disclosed, a packet switching machine having shared high-speed memory with multiple ports, one port coupled to a plurality of LAN controller chips coupled to individual LAN segments and an Ethernet microprocessor that sets up and manages a receive buffer for storing received packets and transferring pointers thereto to a main processor. The main processor is coupled to another port of the memory and analyzes received packets for bridging to other LAN segments or forwarding to an SNMP agent. The main microprocessor and the Ethernet processor coordinate to manage the utilization of storage locations in the shared memory. Another port is coupled to an uplink interface to higher speed backbone media such as FDDI, ATM etc. Speeds up to media rate are achieved by only moving pointers to packets around in memory as opposed to the data of the packets itself. A double password security feature is also implemented in some embodiments to prevent accidental or intentional tampering with system configuration settings.

U.S. Pat. No. 6,104,373 to Klein issued Aug. 15, 2000 and entitled “Apparatus for displaying data on a video display” discloses method and apparatus for displaying data on a video display that is controlled by a video controller, the video controller is coupled to a high-speed memory and a low-speed memory. The memories have separate data paths. A video address corresponding to a location on the video display is received. If a specified address bit is in a first state, then data is displayed from the high-speed memory. If the specified address bit is in a second state, then data is displayed from the low-speed memory. The specified address bit may be a high order address bit that is not utilized by a conventional VGA controller to transmit address information.

U.S. Pat. No. 6,717,952 to Jones, et al. issued Apr. 6, 2004 and entitled “Method and apparatus for media data transmission” discloses methods and apparatus for processing media data for transmission in a data communication medium. A set of data indicates how to transmit a time related sequence of media data according to a transmission protocol. The set of data, includes a time related sequence of data which is associated with the time related sequence of media data. The set of data may be utilized by a digital processing system to transmit the time related sequence of media data (e.g., by packets generated according to the transmission protocol and the set of data).

U.S. Pat. No. 6,961,327 to Niu issued Nov. 1, 2005 and entitled “TCP aware local retransmissioner scheme for unreliable transmission network” discloses a local retransmission scheme, which uses Transport Control Protocol (TCP) in an unreliable network. It provides reliable transmission for out-of-order TCP data packet in an unreliable link. It recovers non-congestion loss packets. It avoids incorrect adjustment of window size in TCP source end. It applies TCP local retransmission scheme, which checks together a link layer transfer sequence and a TCP source delivery sequence. With inserting timestamp of local sequence number, which is in TCP data packet and TCP acknowledgement packet, together with acknowledgement number AN, it is defined whether a data packet is lost and retransmitted. Then, with explicit retransmission ERN feedback, a TCP source false action is avoided. Therefore TCP performance of a wireless network is greatly improved.

United States Patent Publication No. 2003/0202480 to Swami, published on Oct. 30, 2003 and entitled “Method and system for throughput and efficiency enhancement of a packet based protocol in a wireless network” discloses a method and system for employing the time stamp and SACK options in TCP and SCTP to modify their operation to initially only send new or lost packets, after a network timeout has occurred. Wireless network resources are saved by reducing the number of packets that are resent to a destination. In particular, the invention detects whether an acknowledgement from a destination is associated with the originally sent packet or a resent packet and uses this information to modify the operation of the protocol to reduce congestion on the network.

United States Patent Publication No. 2003/0212821 to Gillies, et al. published on Nov. 13, 2003 and entitled “System and method for routing packets in a wired or wireless network” discloses a system and method for routing packets over wireless and wired networks. The system employs an attribute routing scheme that routes communication packets that include objects containing network optimization parameters that are used to control the physical links in the network. The routing transport protocol is logically separated from the objects that are routed, which allows objects having new optimization parameters beyond the conventional network topology parameters or network link parameters to be defined and propagated throughout the network. Additionally, new dynamic routing objects of arbitrary size can be defined that have a customizable update period. These dynamic routing objects are propagated through the network based on their respective custom update periods. The system also includes a feature that enables exponential backoff in the custom update periods. Updates may also be linked to one another, enabling network clients to query the network for related information resulting in efficient implementation of a networking system.

United States Patent Publication No. 2004/0146063 to Golshan, et al. published on Jul. 29, 2004 and entitled “Methods and devices for transmitting data between storage area networks” discloses methods and devices for transmission of data between storage area networks. According to some aspects of the invention, methods are provided for processing data packets sent by, or received from, a storage area network. Some such aspects of the invention involve storing a packet (or a portion of a packet) in a single memory location during an encapsulation or de-encapsulation process. Instead of repeatedly copying the packet during processing, pointer information is passed along that indicates the single memory location. In some aspects of the invention, the segment boundaries of a packet are retained after data transmission. If data in the packet need to be re-transmitted, the packet is re-transmitted with the same segment boundaries.

United States Patent Publication No. 2005/0149481 to Hesselink, et al. published Jul. 7, 2005 and entitled “Managed peer-to-peer applications, systems and methods for distributed data access and storage” discloses applications, systems and methods for accessing and controlling data of devices among multiple computers over a network. Peer-to-peer exchanges of data between private computers is made possible while providing firewall-compliant connectivity. Such functionality is available among private users over a public network, and even when multiple firewalls must be passed through. A firewall compliant connection may be established between a local computer and at least one remote computer; at least one file on a storage device associated with one of the computers is selected, and securely sent to at least one other computer over the secure connections. Computers may be connected over a wide area network with or without a connection server, with or without a VPN.

United States Patent Publication No. 2006/0039283 to Sturrock; et al. published on Feb. 23, 2006 and entitled “Data packet transmission” discloses data packet transmission that involves transmitting a plurality of data packets from said first station to a second station at a first rate of transmission. Acknowledgement data is returned from the second station to the first station to acknowledge the receipt of data packets at the second station. Data packets that are not acknowledged are retransmitted from said first station to said second station. The first station monitors retransmit information indicating how many packets are retransmitted and adjusts said rate of transmission from said first rate to a second rate in response to an output of a control procedure that receives said retransmit information as an input.

United States Patent Publication No. 2006/0047947 to Langworthy; et al. published on Mar. 2, 2006 and entitled “End-to-end reliable messaging with complete acknowledgement” discloses reliable end-to-end messaging in which tracking and acknowledgement information are contained in the electronic message that is visible to layers above the transport layer, thereby being independent of what transport protocols, and whether different transport protocols, are used to communicate between the two end points. Furthermore, acknowledgment messages may identify multiple ranges of sequence numbers corresponding to receive electronic messages, thereby permitting further flexibility and completeness in acknowledging received messages.

United States Patent Publication No. 2006/0129723 to Green; et al. published Jun. 15, 2006 and entitled “Retry strategies for use in a streaming environment” discloses strategies for performing retry analysis in an environment which involves the transmission of media information from a source module to a target module. In the context of the source module, the retry analysis determines whether the source module should satisfy the retry requests issued by the target module. In the context of the target module, the retry analysis determines whether the target module should generate the retry requests in the first place. Request reporting formats are also described. The target module performs analysis to determine what reporting format it should use to convey the retry requests to the source module.

Despite the foregoing, prior art approaches to data storage typically suffer from one or more common deficiencies, including: (i) limitations with respect to the transmitted data size or rate (so as to avoid consuming large amounts of memory to facilitate re-transmission); and/or (ii) the necessity to store a large amount of data in RAM to facilitate any required re-transmissions. Both of these deficiencies place significant restrictions on the host device, especially where available RAM is limited.

Therefore, there is a need to provide improved storage methods and apparatus in data transmission systems in order to overcome and/or minimize these deficiencies. Ideally such a device would improve the efficiency of the transmission or re-transmission of data in small devices (e.g., mobile or hand-held wireless client devices). The efficiency would ideally be achieved in devices with limited memory (e.g., RAM) due to size and/or cost considerations. The present invention fulfills these needs by providing, inter alia, a re-transmission buffer organized to hold multiple records types, and utilizing a single (or circular) re-transmission buffer between two networked hosts.

Such improved methods and apparatus would find particular utility in the exemplary context of a retransmission-enforced environment such as that of the well-known Transmission Control Protocol (TCP), wherein it is necessary to be able to retransmit data that has already been transmitted until an acknowledgement of the data is received (indicating that the data was received at its destination).

### SUMMARY OF THE INVENTION

The present invention satisfied the foregoing needs by disclosing, inter alia, improved methods and apparatus for data storage and processing that reduce storage requirements.

In a first aspect of the invention, a retransmission buffer management architecture is disclosed. In one exemplary embodiment, the retransmission buffer is configured to store multiple record types, and parse transmitted data associated with both volatile and non-volatile storage according to these record types. Data sourced from RAM (volatile) is stored within the retransmission buffer space in its entirety. However, data sourced from ROM/Flash memory will continue to be stored in the original non-volatile storage location, and only a reference record will be stored inside the retransmission buffer space. This economizes on consumption of buffer space since the reference record consumes much less storage space than the actual ROM/Flash data it references.

In a second aspect of the invention, a common or single transmission buffer architecture is disclosed. In one embodiment, the transmission buffer is implemented as a circular or ring buffer having a plurality of pointers (e.g., GET, PUT and ACK) that are used to manage buffer writes, reads and acknowledgements, thereby allowing multiple entities or processes to share a common buffer while implementing the foregoing buffer management techniques to economize on buffer usage in support of retransmission functions.

In a third aspect of the invention, a Serial-to-Ethernet converter including the aforementioned re-transmission buffer functionality is disclosed. In one embodiment, this converter is employed on an embedded device having minimal RAM.

In a fourth aspect of the invention, a method to minimize storage usage during retransmission is disclosed. In one embodiment, the storage comprises random access memory, and the method comprises storing references to non-volatile data stored in ROM or Flash memory within a RAM buffer (as opposed to storing the non-volatile data itself in the RAM buffer), thereby reducing the load on the RAM buffer to support retransmission of data such as required under the TCP protocol.

In a fifth aspect of the invention, an electronic device comprising an optimized retransmission buffer is disclosed. In one embodiment, the device comprises a portable electronic device such as a WiFi-enabled laptop computer or PDA. In another embodiment, the device comprises a personal computer (PC) or server.

In a sixth aspect of the invention, a method of data transmission or retransmission is disclosed. In one embodiment, the method comprises: evaluating a memory address associated with said data; determining based at least in part on said evaluating whether the address indicates a first type of association; if said determining indicates said first type of association, then storing the data inside transmission/retransmission buffer formed at least in part within random access memory (RAM); if said determining indicates said second type of association, then storing only one or more reference parameters associated with said data in said buffer, and storing said data inside a non-volatile storage location, thus reducing load on said transmission buffer.

In a seventh aspect, a data network adapted for efficient retransmission is disclosed.

In an eighth aspect of the invention, a network interface card (NIC) with improved transmission/retransmission functionality is disclosed.

### BRIEF DESCRIPTION OF THE DRAWINGS

FIG. 1 is a graphical illustration of an exemplary request buffer implementation and data stream.

FIG. 2 is a graphical illustration of an exemplary response buffer implementation and data stream.

FIG. 3 is a graphical illustration of an exemplary TCP data exchange between two hosts.

FIG. 4 is a block diagram illustrating an exemplary implementation of a circular or ring buffer used as a common buffer between two or more entities.

FIGS. 4a-4i are graphical representations of the various states of a Serial-to-Ethernet circular buffer implementation according to one embodiment of the invention.

FIG. 5 is a block diagram illustrating an exemplary integrated circuit employing the source-specific buffering techniques of the present invention.

FIG. 6 is a logical flow diagram of one embodiment of the generalized method of source-specific buffering according to the invention.

FIG. 6a is a logical flow diagram illustrating one exemplary implementation of the generalized method of FIG. 6.

FIG. 6b is a logical flow diagram illustrating an exemplary process for providing reference elements for ROM or Flash-based data according to the invention.

FIG. 6c is a logical flow diagram illustrating one exemplary method of providing a function callback to regenerate data for retransmission.

FIG. 6d is a graphical illustration of the various functional entities required to implement a compressed data storage function.

FIG. 6e is a logical flow diagram of an exemplary method of implementing a circular buffer scheme (serial-to-TCP) according to the invention.

FIG. 6f is a logical flow diagram of an exemplary method of implementing a circular buffer scheme (TCP-to-serial) according to the invention.

FIG. 7 is a block diagram illustrating one exemplary embodiment of a serial-to-Ethernet converter used with a host device.

### DETAILED DESCRIPTION

Reference is now made to the drawings wherein like numerals refer to like parts throughout.

As used herein, the term “buffer” refers generally to a reserved segment of memory or storage used to hold data while it is being processed, or in anticipation of other uses. A buffer function may be implemented for example within existing RAM, or in a dedicated stand-alone storage device.

As used herein, the terms “client device” and “end user device” include, but are not limited to, personal computers (PCs), and minicomputers, whether desktop, laptop, or otherwise, set-top boxes (e.g., DSTBs), and mobile devices such as handheld computers, PDAs, personal media devices (PMDs), such as for example an iPod™, “video iPod”, or Motorola ROKR, and smartphones.

As used herein, the term “computer program” or “software” is meant to include any sequence or human or machine cognizable steps which perform a function. Such program may be rendered in virtually any programming language or environment including, for example, C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (BREW), and the like.

As used herein, the term “Ethernet” refers generally to local area network technology; including that now specified in a standard IEEE 802.3 and related standards.

As used herein, the term “integrated circuit (IC)” refers to any type of device having any level of integration (including without limitation ULSI, VLSI, and LSI) and irrespective of process or base materials (including, without limitation Si, SiGe, CMOS and GaAs). ICs may include, for example, memory devices (e.g., DRAM, SRAM, DDRAM, EEPROM/Flash, ROM), digital processors, SoC devices, FPGAs, ASICs, ADCs, DACs, transceivers, memory controllers, and other devices, as well as any combinations thereof.

As used herein, the terms “Internet” and “internet” are used interchangeably to refer to inter-networks including, without limitation, the Internet.

As used herein, the term “internet protocol” or “IP” refers generally to the format of packets, also called datagrams, and/or an addressing scheme, such as without limitation those described in inter alia, RFC 791 and 2460. IP may be used as an identifier for a computer or device on a TCP/IP or comparable network; e.g., such as networks using TCP/IP route messages based on the IP address of the destination.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the terms “microprocessor” and “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), microcontrollers, array processors, and application-specific integrated circuits (ASICs). Such digital processors may be contained on a single unitary IC die, or distributed across multiple components.

As used herein, the term “network” refers generally to any type of telecommunications or data network including, without limitation, data networks (including MANs, WANs, LANs, WLANs, internets, and intranets), hybrid fiber coax (HFC) networks, satellite networks, and telco networks. Such networks or portions thereof may utilize any one or more different topologies (e.g., ring, bus, star, loop, etc.), transmission media (e.g., wired/RF cable, RF wireless, millimeter wave, optical, etc.) and/or communications or networking protocols (e.g., SONET, DOCSIS, IEEE Std. 802.3, ATM, X.25, Frame Relay, 3GPP, 3GPP2, WAP, SIP, UDP, FTP, RTP/RTCP, H.323, etc.).

As used herein, the term “network entity” refers to any network entity (whether software, firmware, and/or hardware based) adapted to perform one or more specific purposes. For example, a network entity may comprise a computer program running in server belonging to a network operator, which is in communication with one or more processes on a CPE or other device.

As used herein, the term “network interface” refers to any signal, data, or software interface with a component, network or process including, without limitation, those of the Firewire (e.g., FW400, FW800, etc.), USB (e.g., USB2), Ethernet (e.g., 10/100, 10/100/1000 (Gigabit Ethernet), 10-Gig-E, etc.), MoCA, Serial ATA (e.g., SATA, e-SATA, SATAII), Ultra-ATA/DMA, Coaxsys (e.g., TVnet™), radio frequency tuner (e.g., in-band or OOB, cable modem, etc.), WiFi (802.11a,b,g,n), WiMAX (802.16), PAN (802.15), or IrDA families.

As used herein, the term “protocol” refers generally to a standard format agreed upon for communication between entities, such as distributed systems within a network. Examples of protocol include (Transmission Control Protocol (TCP), Internet Protocol (IP), TCP/IP, Hypertext Transmission Protocol (HTTP), Session Initiation Protocol (SIP), Real Time Transport Protocol, Real Time Control Protocol (RTP/RTCP), etc.)

As used herein, the term “TCP/IP” refers generally to Transmission Control Protocol/Internet Protocol, the suite of communication protocols used to connect hosts on the Internet.

As used herein, the term “server” refers to any computerized component, system or entity regardless of form which is adapted to provide data, files, applications, content, or other services to one or more other devices or entities on a computer network.

As used herein, the term “Wi-Fi” refers to, without limitation, any of the variants of IEEE-Std. 802.11 or related standards including 802.11a/b/g/n.

As used herein, the term “wireless” means any wireless signal, data, communication, or other interface including without limitation Wi-Fi, Bluetooth, 3G, HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, analog cellular, CDPD, satellite systems, millimeter wave or microwave systems, acoustic, and infrared (i.e., IrDA).

### Overview

The present invention provides, in one salient aspect, an innovative transmission or re-transmission buffer implementation applicable to, inter alia, small devices (e.g., mobile or hand-held wireless client devices) with flash memory. One key benefit provided by the invention is increased transmission performance for devices with limited memory (e.g., RAM). In one embodiment, the invention provides a TCP re-transmission buffer organized to hold multiple records types, and utilizing a single (or circular) re-transmission buffer between two networked hosts. The hosts may be connected over a wired interface (e.g., Ethernet) or alternatively a wireless interface (e.g., WiFi, PAN, WiMAX, etc.).

The present invention finds particular utility in the exemplary context of a retransmission-enforced environment such as that of the well-known Transmission Control Protocol (TCP), wherein it is necessary to be able to retransmit data that has already been transmitted until an acknowledgement of the data is received (indicating that the data was received at its destination). Specifically, prior art approaches to providing this functionality require either: (i) limiting the transmitted data size or rate (so as to avoid consuming large amounts of memory to facilitate re-transmission); or (ii) storing a large amount of data in RAM to facilitate any required re-transmissions. Both of these options place significant restrictions on the host device, especially where available RAM is limited.

In the exemplary embodiment of the invention, the memory address or other locating information associated with the data being transmitted is evaluated at run-time. If the address location indicates a first type of address or association (e.g., within RAM), then the entire content of the data is stored inside the transmission/retransmission buffer. However, if the address location or association indicates another storage area (e.g., ROM/Flash memory address), then the buffer only stores an abbreviated set of identification or reference parameters, such as the address location (pointer) and data size, in the transmission buffer. The actual data is stored inside the non-volatile memory at the designated address (in Flash/ROM), thus reducing the load on the RAM-based transmission buffer.

In another aspect, a call-back function (or subroutine) is used to regenerate the data being re-transmitted.

Also, if the data requested for retransmission is stored in compressed form at a RAM, ROM, or Flash memory address, then a separate reference for each type of data can be used to reduce load on the transmission buffer, and to differentiate between the types of data sources (thereby allowing a more granular control over the storage and retransmission of the different types of data).

Another embodiment of the invention employs a circular buffer with a plurality of pointers (e.g., a GET, PUT and ACK) or other references so that one or more serial ports of the host device can share a common transmission buffer with a data (e.g., TCP) stream.

In another aspect, the invention discloses implementing a re-programmable area within storage (e.g., Flash memory) to be used to store information that will be requested by external systems/clients.

### DETAILED DESCRIPTION

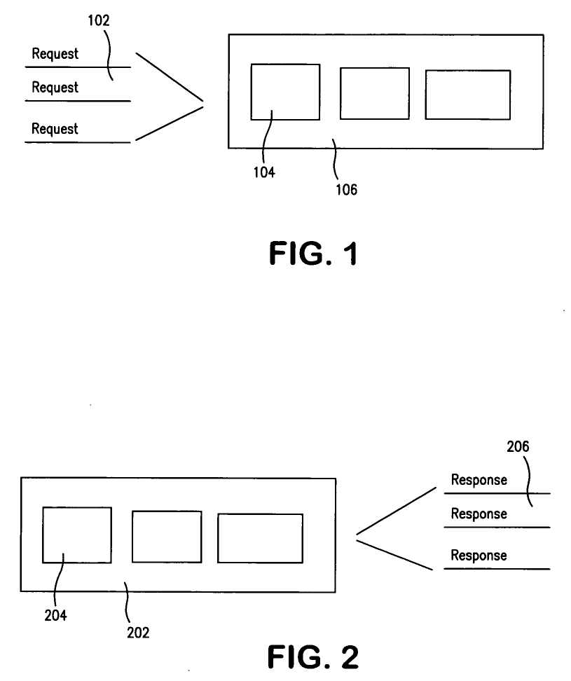

Referring now to FIGS. 1-8, exemplary embodiments of the various aspects of the invention are described in detail.

It will be appreciated that while the following discussions are cast primarily in terms of TCP, the present invention can be equally applied to other technologies and protocols, and is in no way limited to TCP or internetworks such as the Internet.

Moreover, while described in terms of an embedded device having both RAM and flash memory, it will be recognized by those of ordinary skill that the various aspects of the invention are in no way so limited. For example, the invention can be applied to stand-alone PCs, servers, etc. that are not power-limited or mobile, or which may use other types of storage.

Lastly, it will be appreciated that while certain aspects or functions of the invention are described in terms of software or microcode, these functions may also be implemented in firmware or even hardware.

### Avoiding Retransmission Bottlenecks—

In a typical small microcontroller or certain embedded-optimized RISC processors, the device has a small share of available RAM to hold data, and a larger body of memory that is fixed (such as Flash or ROM). To facilitate the efficient processing and support of protocols such as TCP, these devices must be designed with adequate amounts of RAM and ROM/Flash memory to facilitate the TCP re-transmission sequence, especially in cases that packets are lost during transmission over networked connections. In a typical TCP implementation, the device RAM facilitates re-transmission of data that has been sent by storing it until the receiving host acknowledges the receipt of the data sent. This requirement to store the transmitted data until an “ACK” is received can cause significant bottlenecks in terms of data bandwidth, stemming primarily from monopolization of the available RAM resources for such retransmission-related uses.

The present invention addresses this issue (particularly in devices with limited RAM capabilities available) by in one aspect allowing for Flash/ROM memory storage to effectively “share” the responsibility of storing data before re-transmission. For example, a web server implementing the invention would as a response to a transaction (such as serving a web page that displays the current GMT-referenced time or temperature), provide both fixed parts that are stored in Flash or ROM, and variable parts that are stored in RAM. The vast majority of the web page is fixed and can be stored in non-volatile memory, and a very small amount (e.g., the time or temperature) varies and is stored in RAM. Accordingly, the present invention would allow the re-transmission buffer logic to determine that the majority of data for the requested web page is sourced from Flash/ROM, and therefore only save within the transmission buffer: (i) the very small dynamic or “RAM” portion; and (ii) a reference to the larger portion stored in Flash/ROM. This greatly economizes on RAM consumption associated with re-transmission functions.

### TCP Request/Response Streams—

Referring now to FIGS. 1-2, an exemplary TCP data request stream and data response stream of the type used with the invention is described in detail.

As is well known, TCP enables two hosts to establish a connection and exchange streams of data. TCP guarantees delivery of data, and also guarantees that packets will be delivered in the same order in which they were sent.

As shown in FIG. 1, the basic data request stream associated with a given host or entity is comprised of one or more requests 102 that are assembled in an order 104 inside a transmission buffer 106 before the TCP connection stream communicates these requests with another device (e.g., a distant server process).

In the illustrated embodiment, the transmission buffer 106 is implemented in RAM, although it will be appreciated that other types of storage devices may be used depending on the desired application and architecture. As is well known, “RAM” or random access memory refers generally to computer memory that can be accessed randomly; that is, any byte of memory can be accessed without access to the preceding or subsequent bytes. So-called “Dynamic RAM” (DRAM) must be refreshed frequently (e.g., thousands of times per second) or loss of data can occur. Conversely, Static RAM (SRAM) does not need to be refreshed, which makes it faster than DRAM, but it is also more expensive on a per-Mb basis than DRAM. Both types of RAM can be volatile, meaning that they can lose their contents when not powered, while read-only memory (ROM) is typically static or non-volatile in this regard.

Advantageously, the present invention can in certain applications be made agnostic to the specific implementation of the different types of storage; literally any form of readable and writable storage device capable of at least temporarily storing data may be used to implement the transmission/retransmission buffer described herein. Rather, the invention merely differentiates across type, without necessarily needing to know what form of storage is associated with a given “type”.

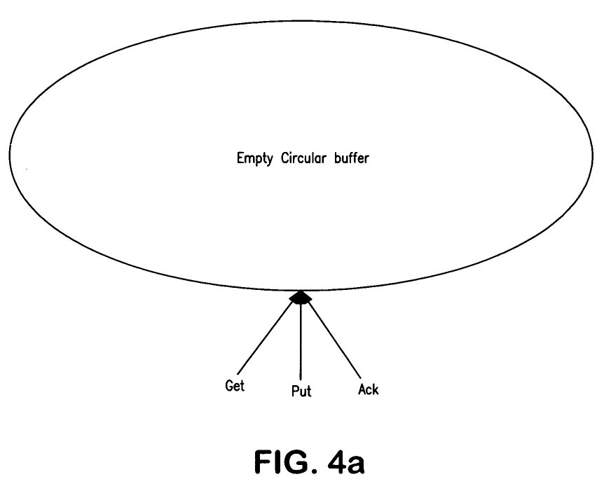

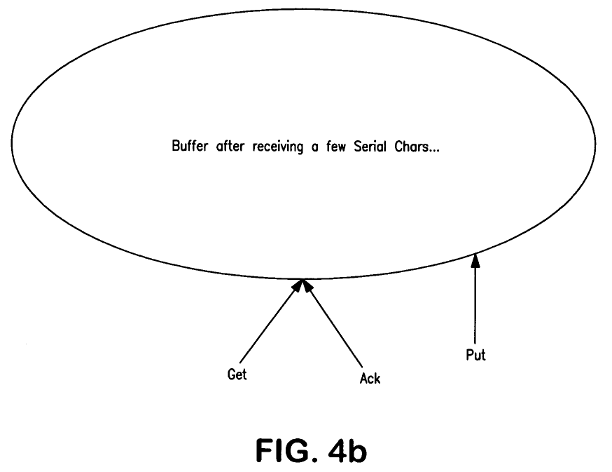

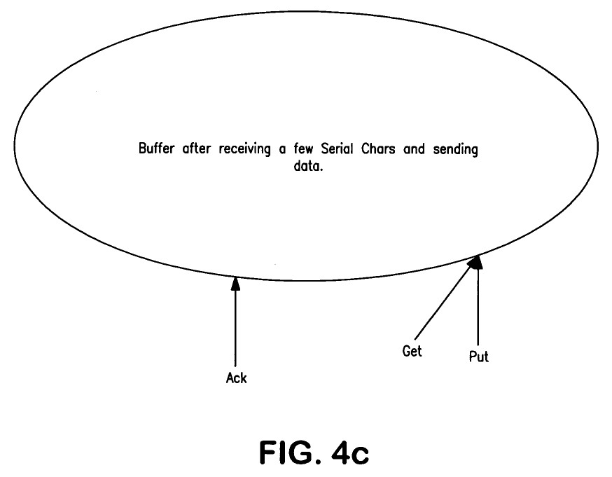

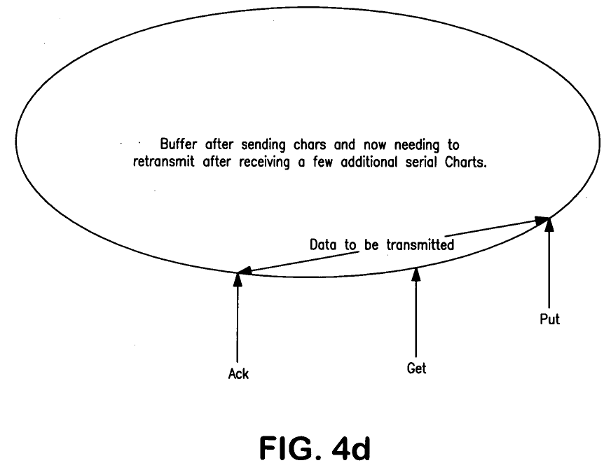

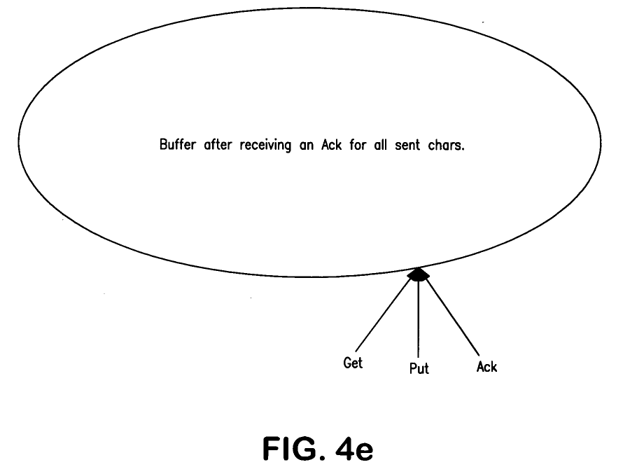

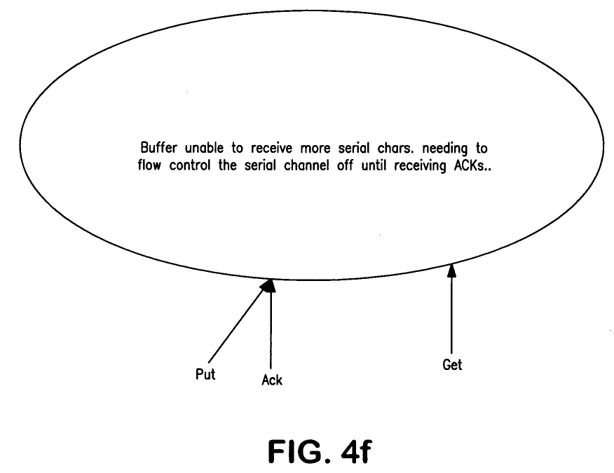

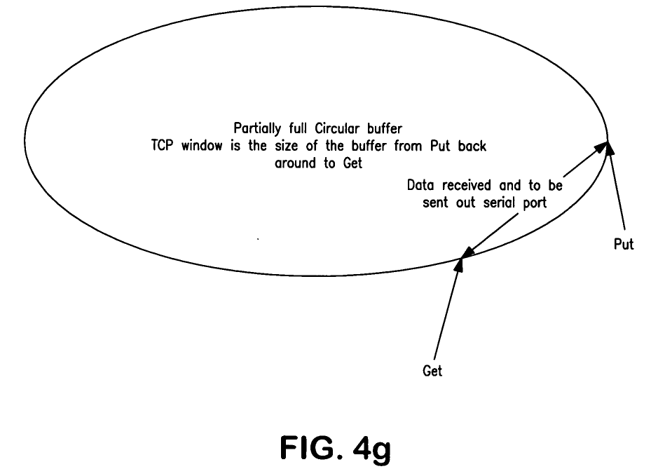

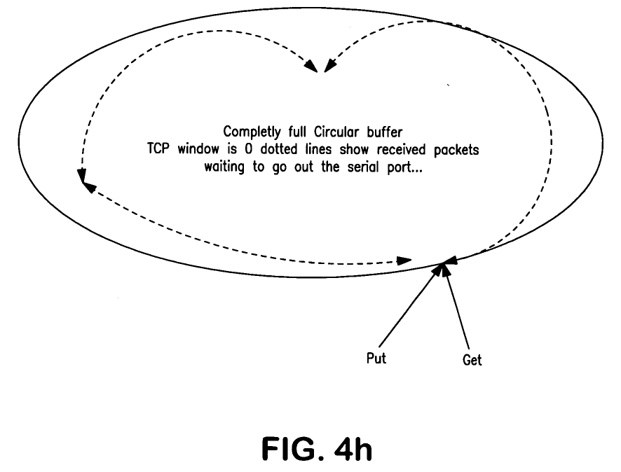

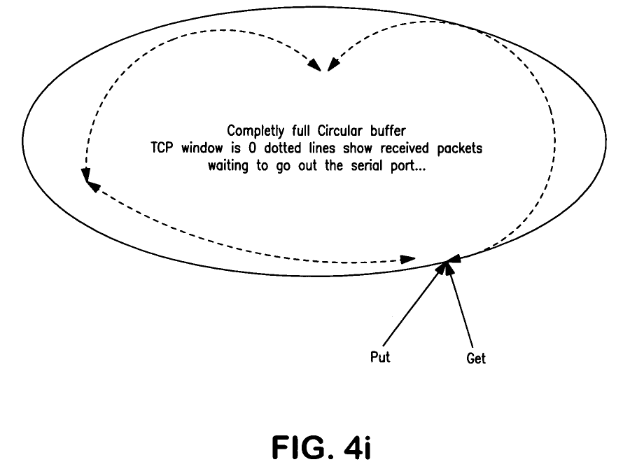

Moreover, different types of buffering schemes can be used consistent with the invention. For example, a FIFO buffer (wherein the first data stored is the first read out of the memory) is commonly used for communications or networking protocols. However, a LIFO or last-in-first-out scheme could feasibly be used (depending on the particular protocol). A circular buffering scheme is also described subsequently herein with respect to FIG. 4.

Additionally, multiple buffers or queues can be employed to form the transmission “buffer” shown; e.g., in conjunction with multi-channel transmission architectures across a transmission or switch fabric such as for example the Motorola/Freescale “RAPIDIO” approach, or an ATM non-blocking transmission packet queuing and management system of the type well known in the art. Hence, the present invention contemplates that multiple storage elements can be accessed, written to, and read from in a concerted or selective fashion in order to implement the aims of the invention, which include the conservation of buffer storage space in the case where different types of storage are present (e.g., volatile/non-volatile).

As shown in FIG. 2, the basic data response stream is comprised of a transmission buffer 202 that contains packet data 204 in an organized stream that form the output responses 206 to the requesting client. This buffer 202 may or may not be the same one used for receiving transaction requests (e.g., that of FIG. 1).

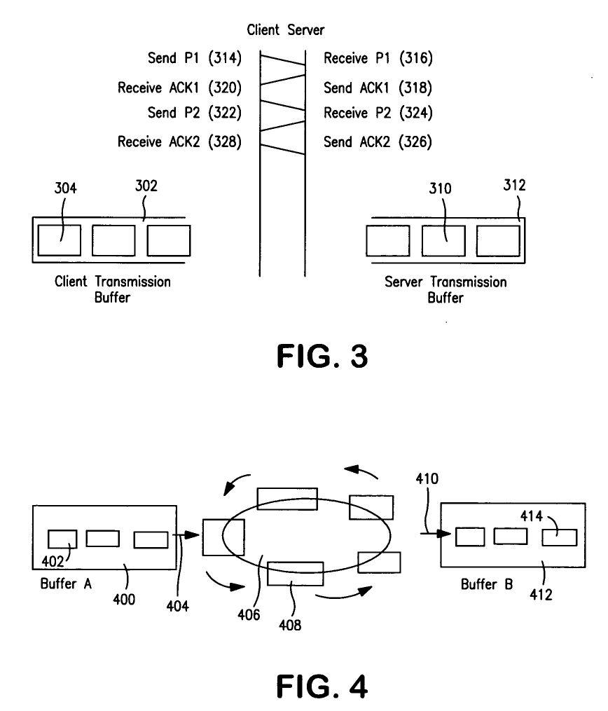

Referring now to FIG. 3, an exemplary TCP transmission buffer protocol is described in the context of a client-server process. The input transmission buffer 302 for the Client device or process contains stream of data packets 304 disposed within the buffer in prescribed sequence to be transmitted to a server transmission buffer 312 that also receives packets 310 from the TCP transmission stream. According to the transmission protocol, these received packets should be presented in order; however, the present invention also contemplates that the packets may be received out-of-order, such as when a protocol that does not enforce such ordered delivery is used (e.g., wherein a jitter buffer and reduced or no QoS is present such as in a VoIP or RTP/RTCP-based system).

The client connection interface (not shown) sends an initialization packet (P1) per step 314 to the Server process, and waits for acknowledgement. The Server connection interface receives the P1 packet (step 316), and sends a positive acknowledgement per step 318 that the packet was received without error via transmission. The client then sends a continuous or bursted series of packets (P2) per step 322 to the server to be received and positively acknowledged. In this example, P2 is received (step 324) by the Server, and acknowledgement is sent (step 326) from the Server to the Client. The client receives the acknowledgement (step 328) for the second packet (ACK2) thereby confirming that the packet was indeed received on the other end.

### Single (Circular) Transmission Stream—

An exemplary configuration of a single (circular or ring) transmission buffer is shown in FIG. 4. In the exemplary embodiment of FIG. 4, the serial transmission buffer 400 is used to hold data record sets (e.g., data packets) 402 that will interface with another device via the input/output buffer interface 404. The data packets (record sets) utilize the single transmission stream 406, and are sent in synchronized order such as illustrated for record set 408. When the packets reach their destination, they are received by the input/output interface 410 for the remote device. The remote device (B) also contains a transmission buffer 412 that holds data packets (record sets) 414 that are received from the sender (A). The remote buffer 412 may also send data packets (record sets) 414 to the other device (A), and transmit them using the same single transmission stream 406 to arrive at their final destination in the transmission buffer 400 of the first device (A).

The exemplary embodiment of the circular buffer includes three pointers (e.g., a GET, PUT and ACK) that are used to point to different locations within the allocated buffer space. The “GET” pointer indicates where data is to be read from next. The “PUT” pointer indicates where data is to be written to next. The “ACK” pointer indicates the data that has been acknowledged (and accordingly which can be purged or overwritten). These three processes (GET, PUT and ACK) can be decoupled from one another, such as by use of multiple threads or state machines if desired.

This approach of using a circular or ring buffer enables one or more serial ports of the host device to share a common transmission buffer with a data (e.g., TCP) stream. Specifically, the PUT process can be used for writing data to the buffer space (e.g., RAM data to be transmitted/retransmitted), while the GET process can be used for reading data from the buffer space; e.g., upon receipt from a distant transmitter. The ACK process identifies data that has been acknowledged by the distant recipient, and hence which no longer requires retransmission (or which is to be acknowledged to the distant transmitter). To illustrate the operation of the exemplary embodiment of the circular buffer scheme of the invention, a Serial-to-Ethernet circular buffer is now described. In this context, two cases are considered: (i) data is received via TCP connection, and sent via serial port; and (ii) data is received via serial port, and sent out via TCP.

In a typical TCP-to-serial connection implementation, the data is buffered in four places: (1) incoming TCP buffer; (2) queued serial output buffer; (3) incoming serial data buffer; and (4) sent TCP data awaiting ACK. In contrast, the exemplary embodiment of the present invention advantageously shares two circular buffers.

FIG. 4a graphically illustrates an empty circular buffer. In the case of serial receipt to TCP output (case (ii) above), serial data is received one byte at a time. Eventually, via time out or special character (or other variable type), or accumulated number of characters, the system sends the serial data on the network as a TCP packet. FIG. 4b illustrates the state of the buffer of FIG. 4a, after receiving serial characters.

FIG. 4c illustrates the state of the buffer of FIG. 4a, after sending some of the serial data. Depending on whether or not an ACK (acknowledgement) is received from the serial data transmission, a retransmission may be required. In the interim, assuming that more serial characters have been received, the “old” data can be retransmitted, and the newly received data can be transmitted for the first time. After this is completed, the “GET” and “PUT” are in the same place (see FIGS. 4c and 4d); i.e., since the buffer is empty in this case, the GET and PUT pointers are co-located, and waiting for an ACK from the last transmission.

If, on the other hand, an ACK is received with no retransmission needed, the data transmission operations are current (“caught up”), and the circular buffer functions for all intents and purposes as if it is empty (FIG. 4e).

While the buffer is waiting for a TCP ACK, many more serial characters may have been received, and hence flow control for data coming into the buffer must be imposed (FIG. 4f).

Referring now to FIGS. 4g-4i, the exemplary TCP-to-serial circular buffer implementation referenced above (case (i)) is described. In this embodiment, the TCP data is received (e.g., in batches), and serial characters are sent in serial fashion (i.e., one at a time in sequence). Given the “GET” and “PUT” pointers associated with the buffer referenced above, the amount of space available to receive new data can be determined. This “TCP window” or allowed amount of data is then used to impose flow control or another management scheme (see FIG. 4g). FIG. 4h illustrates the condition where the circular buffer is completely full. As the serial port works its way around the buffer (FIG. 4g), the TCP window size will grow. Thus, whenever ACKs or other data are sent over the TCP connection, the flow control window size can be continuously updated.

The TCP connection of the illustrated embodiment will by rule never send more data than the “window”, so the circular buffer can be filled with fast incoming TCP and slow outgoing serial, but advantageously cannot overflow (FIG. 4i).

### Integrated Circuit Device—

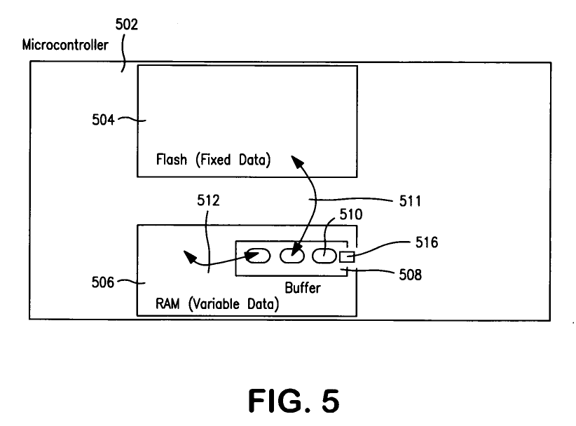

An exemplary serial transmission buffer is shown in FIG. 5, in the context of an integrated circuit (IC) microcontroller. The microcontroller 502 or other IC device (e.g., RISC processor) typically includes an integrated CPU, memory (a small amount of RAM, ROM/Flash, or both), and other peripherals on the same chip. In certain applications, the ROM/Flash memory 504 is larger in size, and can store fixed or non-volatile data. The RAM memory 506 is smaller in size, and stores variable or volatile data. It is often desirable to have both of these different memory storage mediums on a single IC substrate to support different storage needs and reduce fetch and write latencies, etc.

The exemplary transmission buffer architecture of FIG. 5 is responsible for synchronizing data packets (record sets) 510 received/being sent to remote devices via the input/output interface 516, and also for enforcing the retransmission protocol of the invention. In one embodiment, a generic software “write” interface is used to identify data written to the transmission buffer as being RAM- or ROM/Flash-sourced, although it will be appreciated that separate dedicated or type-specific interfaces can be used for this purpose. For example, using traditional programming interfaces, the request to acquire data from memory would resemble the following exemplary script (representing in the illustrated embodiment the source code (e.g., C, C⁺⁺, Pascal, etc.) associated with the standard stream write interface):
[write (socket, data, length]

This code gets parsed, compiled, linked, and reduced to machine instructions according to techniques well known in the software arts. The machine instructions are then executed on the microcontroller of the target device or platform. In this regard, the present invention advantageously allows for the use of a standard programming interface (e.g., write) while still providing the aforementioned benefits of storage (e.g., RAM) savings.

The above mentioned generic write interface code looks at the type of the data pointer and makes a runtime decision as to wither to store a RAM copy or reference element record based on the source address of the provided data.

As the interface reads/parses data, it determines whether that data references either RAM or ROM/Flash memory. A RAM request 514 for example consists of parsing a record set and fetching the data that is stored in RAM for transmission. A ROM/Flash request 511 consists of parsing the record set and fetching the data that is stored in Flash/ROM memory for transmission. At this point, the transmission buffer logic (e.g., generic write interface) further analyzes the aforementioned data requests to determine their source (e.g., RAM or ROM/Flash). This source determination is used by the buffer logic to decide where/how to store the data for retransmission. The source of the data can be determined by evaluating its address (e.g., certain address formats or ranges will correlate to ROM/Flash, and certain others to RAM), although other approaches may be used.

Specifically, if the data being parsed is sourced from RAM, the buffer logic will store the same data within the transmission buffer (or a separate designated “retransmission buffer” portion of RAM). Conversely, if the data being parsed is sourced from ROM/Flash, the logic generates and stores a reference to the ROM/Flash location.

In the exemplary embodiment, the reference comprises an address pointer and length; however, it will be appreciated by those of ordinary skill that other approaches may be used, such as for example referencing an entire row or column (or even an entire array), specifying a relative address (i.e., X bytes following the last data set), and so forth. Any number of different relative or absolute addressing schemes may be used consistent with the invention's aims of merely storing a reference or “link” within the transmission/retransmission buffer to a memory location outside thereof.

In an alternate embodiment, the transmission buffer logic does not physically store the data transmitted in a retransmission buffer, but rather utilizes a callback function or subroutine that will regenerate the transmitted data if retransmission is required. This routine or function operates on data generated at run-time and stored (e.g., within the buffer, or referenced by a pointer, etc. stored within the buffer) and to be used in the event retransmission is needed. For example, the locations of data being transmitted could be stored, such as in RAM or in the one or more registers, and which are read by the callback routine when the latter is invoked upon failure to receive proper transmission acknowledgement. Hence, a “virtual” buffer of sorts is created, wherein merely a description or reference of the transmitted data is retained in the buffer as opposed to a separate local copy of the data itself.

As another example of the “callback” functionality of the invention, consider the display of a web page comprising a “TicTacToe” game (i.e., having a cross-hatch “board” comprising 9 squares in three rows and 3 columns). Since there are nine squares, and the game logic is base-3 (i.e., “X”, “O”, or empty), there are 3⁹ or 19,683 possible states for the game image. In order to render this image in the varying different states it can assume, in HTML or another markup language, significant memory might be required; e.g., many hundreds of bytes to provide links, image references, etc. However, 19,683 states fit easily within two binary data bytes (2¹⁶ or 65,536). Hence, using two bytes, one could easily recreate all 19,683 states of the exemplary TicTacToe board representation.

However, a generic buffer interface does not recognize the features of a TicTacToe game. Accordingly, a mechanism is required to allow such recognition or use of the state information in the proper context. The aforementioned callback data type is used to provide such functionality. Specifically, in the present example, the callback data type comprises an address or pointer to a function to render or translate the stored data into the proper format for its context. For example, the code tasked with output of the TCP stream recognizes the callback data type (provided along with the two bytes of data to indicate state), and accordingly passes the two bytes of state data to the called function (i.e., a routine or other process at the address indicated or pointed-to by the callback record in the buffer). The called routine or function then takes the state data and uses it to populate the network transmission buffer in the proper format (here, a TicTacToe board).

It will be appreciated that the called routine or function can be used to render literally any image or data structure. As another example, a clock image could be portrayed, with the state data comprising a time stamp that tells the routine where to place the hands on the clock. Myriad other such applications will be recognized by those of ordinary skill given the present disclosure.

In still another embodiment, the transmission buffer logic can be configured to compress all or a portion of the locally stored (RAM) data in order to further economize on storage space. Any number of data compression algorithms well known in the art may be used, and accordingly these are not described further herein.

As another alternative, the Flash/ROM data can be compressed and stored locally (e.g., within the retransmission buffer) in place of an address/length or other such reference.

As still another alternative, compressed data stored originally within RAM and/or ROM/Flash can be decompressed for transmission, and merely distinct references (e.g., address and length) for the compressed data, whether RAM or ROM/flash, stored in the retransmission buffer. If retransmission is required, the buffer logic will then read the distinct references and access and decompress the respective data from its original location(s).

### Methods—

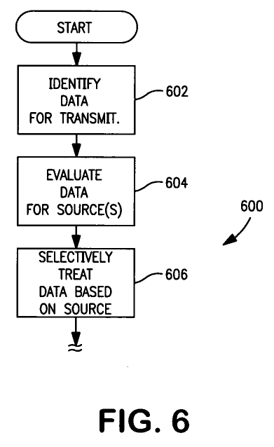

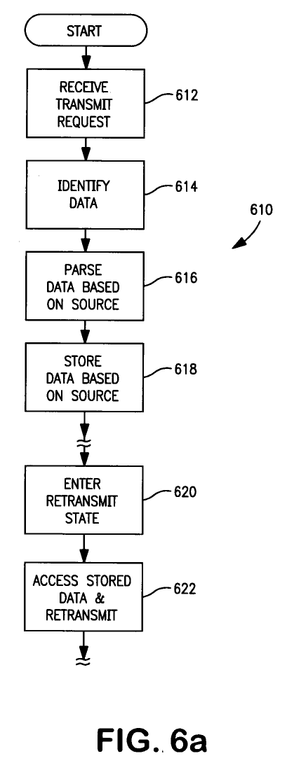

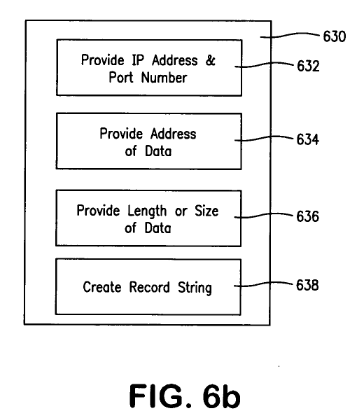

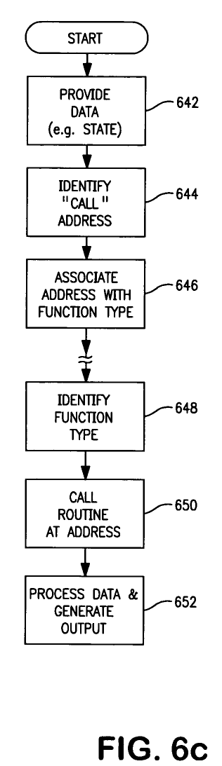

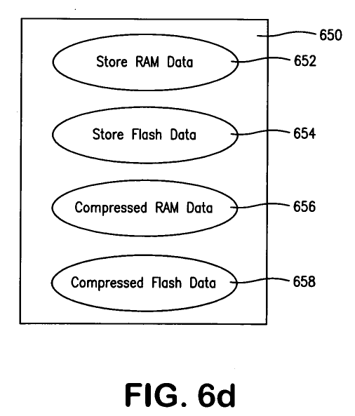

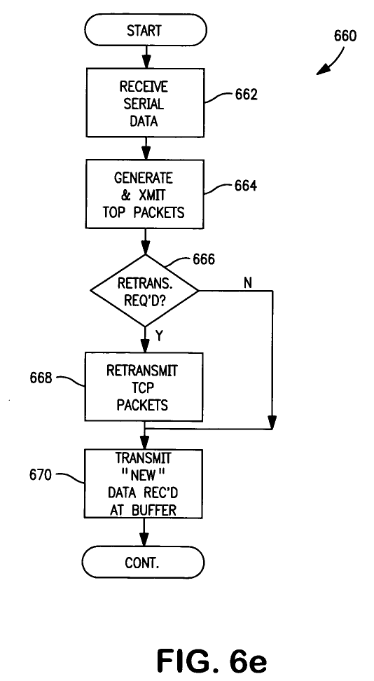

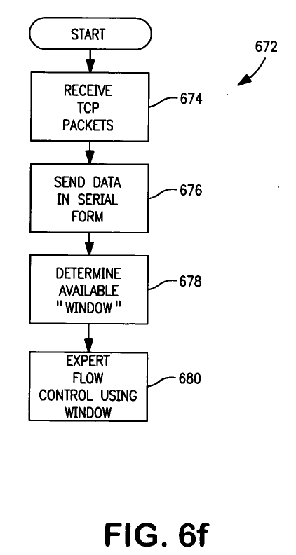

Referring now to FIG. 6, one exemplary embodiment of the generalized methodology of data storage for transmission/retransmission is described.

As shown in FIG. 6, the method 600 comprises first identifying data to be transmitted from a first device or network entity to a second device or entity (step 602). As previously discussed, this data may comprise data sourced from multiple locations or sources (e.g., RAM, ROM/Flash, etc.).

Next, the data identified in step 602 is evaluated to determine the sources associated therewith (step 604). For example, as previously discussed in the context of an Internet web page, the static data may be associated with ROM or Flash memory, while the dynamic or variable data may be associated with RAM.

Per step 606, the data is then “parsed” or selectively treated as applicable based on its source (and optionally other related parameters). For example, such selective treatment might comprise storing the dynamic or variable data with a retransmission buffer (e.g., within RAM), while merely a reference to the storage location of the static data (i.e., in ROM or Flash) is stored in the retransmission buffer. Alternate schemes for selective treatment of the heterogeneous types of data encountered (e.g., compressed/uncompressed, etc.) are described subsequently herein.

Additionally, the method of FIG. 6 may be adapted to utilize a function callback or subroutine comprising e.g., code that will fetch the transmitted data again upon the need for retransmission (as opposed to storing the data or references thereto in a retransmission buffer).

There various techniques can also be intermixed, such as where the RAM or ROM/Flash content is treated in one fashion, and the other treated differently. For example, the invention contemplates that a dynamic assessment of the relative size of the two types of data can be performed, and the treatment of the different types adjusted accordingly (i.e., one treatment may be applied if the size of the ROM/Flash data to be retransmitted greatly exceeds that of the variable or RAM data, and a second treatment applied if the converse is true).

It is noted that in the illustrated embodiment of the method 600, the decision on how to treat the various data “types” is made at run time by looking at the source of the data to be transmitted. This advantageously enables automatic determination of how to store the retransmission data without having to utilize a separate interface to write fixed and variable data. However, as previously noted, separate function-specific interfaces to each of the record types indicated above can be used if desired.

FIG. 6a illustrates one exemplary implementation of the method of FIG. 6. As shown in FIG. 6a, the method 610 comprises receiving a transmission request from another entity (step 612). Next, the data to be transmitted is identified per step 614. The identified data is then retrieved and evaluated at run-time to determine the sources associated therewith (e.g., RAM and ROM/Flash) per step 616. The transmission logic then stores the appropriate data elements or references in their appropriate locations (e.g., RAM-sourced data in the retransmission buffer, and references for the ROM/Flash data in the retransmission buffer as well) per step 618. A retransmit request is then received (such as via a local process-generated primitive in response to timeout on receiving an ACK from the distant entity) per step 620.

The transmission logic then accesses the stored ROM/Flash data via the reference if required for retransmission, and retransmits the stored RAM data and retrieved ROM/Flash data to the distant end (step 622). This process is continued until an appropriate “ACK” is received.

FIG. 6b illustrates an exemplary process 630 for providing reference elements for ROM or Flash-based data according to the invention.

As shown in FIG. 6b, an IP address and a valid port number (i.e., socket) is optionally provided per step 632. This can be used within, e.g., a distributed environment in order to locate the machine or entity with which the data being referenced is associated. For a single or local environment, this data may not be required.

The address of the data is also provided; i.e., where within the ROM or Flash memory the data of interest can be read from (step 634). The reference element also includes a length variable to determine the size of the data being referenced (step 636).

The record string, which includes the address and length, as well optionally the socket information, is then created within a storage location (e.g., a portion of RAM acting as the retransmission buffer) per step 638. This can be in the form of e.g., a Type (fixed size) and a variable size Data field, a tuple (e.g., (a, b, c), or other well known approach. In the case of the aforementioned Type and Data fields, the code is given responsibility to decode the variable size Data field based on the value of the Type field. For example, in one variant, if the Type field comprises “ROM” (or a code reflecting this), then the Data field will comprise a given length field, followed by a pointer to a location for the data.

Alternatively, if the Type field comprises “RAM” or the equivalent, the Data field comprises a length field followed by the actual data.

If the Type field comprises a “Callback” or equivalent, then the Data field comprises a pointer to a routine or function, followed by a length field, followed by the actual data (e.g., state data comprising two (2) bytes as in the previously described TicTacToe example).

It will further be appreciated that different “Types” for the Type field can be added or defined consistent with the invention. For example, one could specify a Type=“Thermostat” which would operate in fundamentally the same way as previously described, by merely adding a new set of functions to call to evaluate/use the variable data (e.g., actual temperature values). Hence, the foregoing methodologies are advantageously both “type” and “data” agnostic.

FIG. 6c is a logical flow diagram illustrating one exemplary method 640 of providing a function callback to regenerate data for retransmission.

As shown in FIG. 6c, the exemplary method first comprises providing state or other data (see exemplary TicTacToe example previously provided) per step 642. Next, the address location(s) for the routine or function to be called to process the state data of interest is identified (step 644). This address or pointer is then associated with a particular function Type (e.g., “callback” Type) per step 646. The designated Type is then recognized during processing (step 648), and the function or routine located at the address called (step 650) to process the state data and generate an output (step 652).

As previously noted, the callback function or routine can be stored within the transmission or retransmission buffer itself, or another location as desired.

FIG. 6d is a graphical illustration of the various functional entities required to implement a compressed data storage function 650. As shown in FIG. 6d, the invention can be adapted to accommodate more than two types of data (e.g., more than RAM and ROM/Flash), including for example (i) various formats of compressed data; (ii) various different types of storage devices not already enumerated (e.g., Flash versus NAND Flash, DRAM versus SRAM, etc.). For example, in one variant of the invention, RAM-sourced data (uncompressed) would be stored in the retransmission buffer, while ROM/flash-sourced data, and compressed RAM-sourced data, were merely referenced via pointer, etc. within the buffer as previously described. Alternatively, the “compressed RAM” data could be stored in compressed format within the retransmission buffer (along with the uncompressed RAM data), while the ROM/Flash data was referenced via pointer, etc.

Hence, while FIG. 6d only illustrates four basic types of storage (i.e., RAM data 652, Flash/ROM data 654, compressed RAM data 656, and compressed Flash/ROM data 658), other data storage media may be available on the device (e.g., microcontroller), and hence the invention is not limited to the illustrated types of storage functions.

FIG. 6e is a logical flow diagram of an exemplary method of implementing a circular transmission buffer scheme according to the invention. In the method 660 of FIG. 6e, a Serial-to-TCP transmission instance is described. Specifically, per step 662, serial data is received at the buffer. TCP packets are then generated based on the received serial data (e.g., based on a predetermined number of characters being received, etc.), and transmitted (step 664). The system waits for an acknowledgement (step 666); if retransmission is required, the old data is retransmitted (step 668), and the newly received data in the interim “packeted” and transmitted (step 670). If retransmission is not required, the data transmission operations are “current”, and the buffer operates as if empty.

FIG. 6f illustrates the TCP-to-Serial instance of the method 672. First, TCP data is received (e.g., in batches) per step 674, and serial characters are sent in serial fashion (i.e., one at a time in sequence) per step 676. Given the “get” and “put” pointers associated with the buffer referenced above, the amount of space available to receive new data can be determined (step 678). This “TCP window” or allowed amount of data is then used to impose flow control or another management scheme (step 680).

It will be appreciated that the methodologies described herein can be applied or utilized in a selective fashion as well, such as where one or more other criteria are used to determine whether the RAM-ROM/Flash source dichotomy is exploited with respect to a particular transaction or re-transmission. For example, it may be desirable to “mask” certain transaction requests from the aforementioned process, in effect allowing them to be treated as under the prior art (i.e., stored agnostically within the transmission buffer irrespective of source), while other unmasked requests are analyzed and processed as described herein. Such masking may serve other goals or optimizations, such as in instances where ROM/Flash memory is at a premium, or latencies associated with the reference (e.g., pointer/length) parameter generation exist and are undesirable, or even as a throttling mechanism.

Similarly, the application of the techniques of the present invention to certain types of transactions may produce little in the way of “compression” (i.e., free up little additional RAM as compared to the prior art approach), where as others may benefit greatly in terms of compression. For example, in the context of the web page serving described above, application of the present invention ostensibly provides a great deal of compression, in that the great preponderance of the total data associated with the serving transaction is stored in Flash/ROM, which would otherwise consume a comparable amount of RAM. In contrast, transactions where the inverse is true (very little of the “served” content is static or Flash/ROM) would provide little compression, and hence may actually be more efficiently handled using the prior art approach (e.g., due to increased processing overhead or latency necessary to generate and store the references, and retrieve the data from Flash/ROM as opposed to directly from RAM).

Moreover, the application of the techniques of the present invention can be applied speculatively or based on statistics. This approach can be useful in non-QoS or lossy types of applications (e.g., audio codecs, VoIP, etc.) where failure to complete transmission of small portions of the data is not critical. Specifically, if the speculation is wrong, there is little if any penalty. Conversely, if the speculation is correct, some other parameter (e.g., RAM or ROM usage, speed, etc.) is optimized.

Moreover, it may be known that certain types of transactions statistically or anecdotally require frequent retransmission, and hence storage in a retransmission buffer would necessarily be enforced since the likelihood of needing the data again is high. Alternatively, in transactions where the retransmission need is statistically or anecdotally low, the storage controller could “speculate” and either (i) not store the data for retransmission at all; or (ii) arbitrate between the prior art “agnostic” approach of storage and the source-specific approach described herein.

### Serial to Ethernet Device

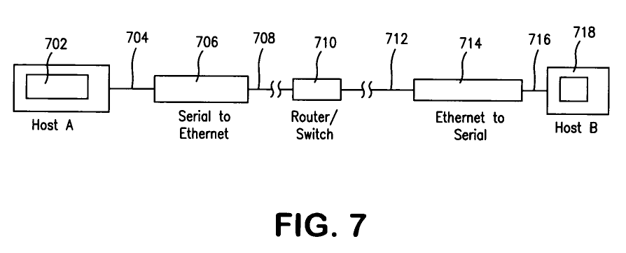

FIG. 7 illustrates the configuration of one exemplary embodiment of a serial-to-Ethernet device implementation of the invention; e.g., where two hosts (Host A and Host B) are in communication with one another across an 802.3 Ethernet network. The first host computer (A) 702 is connected to an Ethernet cable 704 that is also connected to a serial-to-Ethernet interface device 706. This interface device moves data to/from the serial port of the host to the TCP connection. This is typically accomplished with separate TCP and serial buffers for data in both directions, although other approaches may be used with equal success (i.e., the retransmission scheme of the present invention is effectively agnostic to the serial-to-Ethernet interface configuration.

The Ethernet device is also connected to an additional Ethernet cable 708 to the network router/switch. This network configuration allow for multiple host computers to utilize serial input/output streams to transmit data between networked computers. The router may also have external input/output Ethernet connection 712 to another “Serial to Ethernet” device 714 that connects to a remote computer 718 using an Ethernet cable 716.

In the illustrated embodiment, a separate record type is used that couples the serial buffer(s) of the serial-to-Ethernet device(s) to the TCP retransmission function. See previous discussion regarding data “Type” in reference to FIG. 6b.

It will also be appreciated that while certain aspects of the invention have been described in terms of a specific sequence of steps of a method, these descriptions are only illustrative of the broader methods of the invention, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

We claim:

1. A method for reducing storage usage in a device that contains both first and second storage mediums and a transmission buffer, comprising:
evaluating an address location of data to be transmitted;
if said address location indicates an address within said first storage medium, then storing said data inside said transmission buffer; and
if said address location indicates said second storage medium, then:
storing a plurality of identification parameters within said buffer; and
storing said data within said second storage medium.

2. The method of claim 1, wherein said device comprises an embedded mobile device, said first storage medium comprises random access memory (RAM), and said second storage medium comprises a non-volatile memory.

3. The method of claim 2, wherein said plurality of identification parameters comprises: (i) the address location of said data; and (ii) the size of said data.

4. The method of claim 1, wherein said transmission buffer comprises at least a portion of said first storage medium.

5. A retransmission buffer management architecture operating according to a retransmission protocol, the architecture comprising:
a retransmission buffer adapted to parse transmitted data associated with a volatile and a non-volatile storage medium;
wherein said retransmission buffer is further configured to store a plurality of record types, said plurality of record types comprising a full record and a reference record; and
wherein a first data sourced from said volatile storage medium is stored within said retransmission buffer as said full record type and a second data sourced from said non-volatile storage medium is stored within said retransmission buffer as said reference record type.

6. The retransmission buffer architecture of claim 5, wherein said volatile storage medium comprises RAM.

7. The retransmission buffer architecture of claim 5, wherein said non-volatile storage medium comprises flash memory.

8. The retransmission buffer architecture of claim 5, wherein said reference record type comprises: (i) the address location of said second data; and (ii) the size of said second data.

9. The retransmission buffer architecture of claim 5, wherein said retransmission buffer comprises at least a portion of said volatile storage medium.

10. The retransmission buffer architecture of claim 5, wherein said retransmission protocol comprises TCP protocol.

11. A transmission buffer architecture, comprising:
a circular buffer comprising a plurality of pointers, said plurality of pointers adapted to manage said circular buffer writes, reads and acknowledgements, thereby permitting a plurality of entities to share said circular buffer.

12. The transmission buffer architecture of claim 11, wherein said plurality of pointers comprise a GET, a PUT and an ACK pointer.

13. The transmission buffer architecture of claim 12, wherein said ACK pointer indicates that a first data has been acknowledged and therefore may be purged from said circular buffer.

14. The transmission buffer architecture of claim 11, wherein said plurality of entities comprises a volatile and a non-volatile storage medium.

15. The transmission buffer architecture of claim 14, wherein said volatile storage medium comprises RAM.

16. The transmission buffer architecture of claim 15, wherein said non-volatile storage medium comprises flash memory.

17. The transmission buffer architecture of claim 11, wherein said circular buffer and said plurality of entities exist on a single integrated circuit substrate thereby reducing fetch and write latencies associated with said plurality of pointers.

18. The transmission buffer architecture of claim 11, wherein said circular buffer comprises a Serial-to-Ethernet circular buffer.

19. A computerized network-enabled electronic device, comprising:
a first data storage medium;
a second data storage medium;
a transmission buffer comprising at least a portion of at least one of said first and second mediums; and
logic apparatus adapted to:
evaluate an address location of data to be transmitted;
if said address location indicates an address within said first storage medium, store said data inside said transmission buffer; and
if said address location indicates said second storage medium:
store a at least one identification parameter within said buffer; and
store said data within said second storage medium.

20. The device of claim 19, wherein said device comprises a mobile device, said first storage medium comprises random access memory (RAM), and said second storage medium comprises a non-volatile memory.

21. The device of claim 20, wherein said at least one identification parameter comprises: (i) the address location of said data; or (ii) the size of said data.

22. The device of claim 19, wherein said transmission buffer comprises at least a portion of said first storage medium.

23. The device of claim 19, further comprising a digital processor, and wherein said logic apparatus comprises a computer program adapted to run on said processor.

24. The device of claim 19, wherein said logic apparatus comprises firmware.

25. The device of claim 19, further comprising a network interface adapted to transmit packetized data according to a networking protocol.

26. The device of claim 25, wherein said protocol comprises an Ethernet protocol.

27. The device of claim 25, wherein said protocol comprises a protocol requiring retransmission of data that has already been transmitted until an acknowledgement of the data is received from another entity.

28. The device of claim 27, wherein said protocol comprises a protocol that performs said retransmission without limiting the transmitted data size or rate.

29. A method of processing data for transmission or retransmission, comprising:
evaluating a memory address associated with said data;
determining based at least in part on said evaluating whether the address indicates a first type of association;
if said determining indicates said first type of association, then storing the data inside transmission/retransmission buffer formed at least in part within random access memory (RAM);
if said determining indicates said second type of association, then storing only one or more reference parameters associated with said data in said buffer, and storing said data inside a non-volatile storage location, thus reducing load on said transmission buffer.
